(19) United States
(12) Patent Application Publication
(10) Pub. No.: US 2007/0165194 A1
(43) Pub. Date: Jul. 19, 2007

(54) Image display apparatus and control method therefor

(75) Inventors: Jung-min Jung, Suwon-si (KR); Jeong-ho Nho, Suwon-si (KR); Koichi Sono, Suwon-si (KR); Yong-Dok Cha, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/651,604

(22) Filed: Jan. 10, 2007

(30) Foreign Application Priority Data
Jan. 18, 2006 (KR) 10-2006-0005578

(51) Int. Cl. G03B 21/28

(52) U.S. Cl. 353/99

(57) ABSTRACT

An image display apparatus comprises a plurality of light sources, each of which outputs light having a different color than the other light sources, and a digital micro mirror device (DMD) panel having a plurality of mirror elements. The plurality of mirror elements reflect light output from the light sources in one of a first direction, for displaying an image, and a second direction different from the first direction. The apparatus further includes a detecting part which detects the quantity of light reflected in the second direction by at least one mirror element of the DMD panel, and an adjusting control part which determines the quantity of light output from the respective light sources based on the detection by the detecting part, and which adjusts light output of the light sources based on the determined quantity of light output from the light sources.

### CROSS-REFERENCE TO RELATED APPLICATIONS

This application claims priority from Korean Patent Application No. 2006-0005578, filed on Jan. 18, 2006 in the Korean Intellectual Property Office, the disclosure of which is incorporated herein by reference.

### BACKGROUND OF THE INVENTION

1. Field of the Invention

Apparatuses and methods consistent with the present invention relate to an image display apparatus and a control method therefor which adjust the light output of respective light sources to thereby prevent image distortion.

2. Description of the Related Art

Projectors are used widely for presentations and various projectors have been under development for improving a portability thereof.

As one of display devices for use in a projector, a digital micro mirror device (DMD) panel is used widely. A DMD panel controls an inclination angle of a plurality of micro mirror elements to reflect light in various directions.

An image display apparatus using a DMD panel focuses white light, output from a light source, on a spot of a color wheel through which light having one color of red, green and blue is transmitted. Then, the light transmitted through the color wheel is irradiated onto the DMD panel in parallel. Then, light reflected by the DMD panel is projected onto a display screen through a zoom projecting lens, and accordingly, an image is displayed. Inclination angles of micro mirror elements of the DMD panel are controlled to display the image. Light reflected in a first direction by the micro mirror elements having a first inclination angle is used for displaying an image through the zoom projecting lens, and light reflected in a second direction by the micro mirror elements having a second inclination angle is not used for displaying an image.

An image display apparatus under development has a plurality of light sources which output light having different colors such as red, green and blue rather than having a color wheel and one light source which outputs a white light. However, in an image display apparatus having a plurality of light sources, if the efficiency of the respective light sources is different, image distortion may be caused.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image display apparatus and a control method therefor wherein a light output of a light source is adjusted by using an off light which is not used for displaying an image, thereby preventing image distortion.

According to an aspect of the present invention, there is provided an image display apparatus, comprising a plurality of light sources which each output light having a color different from the other light sources; a digital micromirror (DMD) panel comprising a plurality of mirror elements which reflect light output from the light sources in one of a first direction for displaying an image and a second direction different from the first direction; a detecting part which detects the quantity of light reflected in the second direction; and an adjusting control part which determines the quantity of light output by the light sources based on the detention by the detecting part, and adjusts a light output of the light sources based on the determined quantity of light.

According to another aspect of the present invention, the detecting part comprises a light sensor which detects light and outputs, to the adjusting control part, a voltage level corresponding to the quantity of the detected light.

According to another aspect of the present invention, the adjusting control part determines the intensity of light output from the light sources based on the voltage level output by the detecting part, determines a weight value for the light sources so that the determined intensity of light output by the light sources corresponds to a predetermined reference intensity of light output by the light sources, and adjusts the light output of the light sources based on the weight value.

According to another aspect of the present invention, the adjusting control part determines the intensity of light output from the light sources based on the quantity of light reflected in the second direction detected by the detecting part, determines a weight value for the light sources so that the determined intensity of light output by the respective light sources corresponds to a predetermined reference intensity for light output by the light sources, and adjusts the light output of the light sources based on the weight value.

According to another aspect of the present invention, the adjusting control part determines a relative intensity of light output from the light sources based on the quantity of light detected by the detecting part, determines a weight value for the light sources so that the determined relative intensity of light of the light sources corresponds to a predetermined relative reference intensity, and adjusts the light output of the light sources based on the weight value.

According to another aspect of the present invention, to control the light output of the light sources according to the weight value, the adjusting control part adjusts one of the amount of a driving current supplied to the light sources and a duty ratio for driving the light sources, to control the light output of the light sources according to the weight value.

According to another aspect of the present invention, the adjusting control part adjusts the light output of the light sources based on a predetermined period of time.

According to another aspect of the present invention, the light sources comprise a red light source which outputs red light, a green light source which outputs green light, and a blue light source which outputs blue light, wherein each of the red light source, the green light source, and the blue light source comprises one of a light emitting diode (LED) and a laser.

According to another aspect of the present invention, the image display apparatus further comprises a display part which displays an image, and a panel driving part which controls the DMD panel so that each of the mirror elements is disposed to reflect in one of the first direction and the second direction based on an input image signal, and controls the display part to display an image according to the image signal.

According to another aspect of the present invention, there is provided a control method for an image display apparatus, comprising a DMD panel from which light is reflected in one of a first direction and a second direction. The method comprises: providing a plurality of light sources which each output light having a color different form the color of the other light sources; detecting a quantity of light reflected by the DMD panel in the second direction; determining q quantity of light output by the light sources based on the quantity of light detected; and adjusting a light output of the light sources based on the determined quantity of light output by the light sources.

According to another aspect of the present invention, detecting a quantity of light reflected by the DMD panel in the second direction is performed by a detecting part comprising a light sensor which detects light and outputs a voltage level corresponding to the detected quantity of light reflected by the DMD panel in the second direction.

According to another aspect of the present invention, determining the quantity of light output by the light sources comprises: determining an intensity of light output from the light sources based on the voltage level output by the detecting part; and determining a weight value for the light sources so that the determined intensity of light of the light output from the light sources corresponds to a predetermined reference intensity for the light output by the light sources.

According to another aspect of the present invention, the determining the quantity of light comprises determining a relative intensity of light output from the respective light sources based on the voltage level output by the detecting part, and determining a weight value for the light sources so that the determined relative intensity of light output by the light sources corresponds to a predetermined relative reference intensity for the light output by the light sources.

According to another aspect of the present invention, adjusting the quantity of light output by the light sources comprises adjusting the quantity of light output by the light sources based on the determined weight value.

According to another aspect of the present invention, adjusting the quantity of light output by the light sources further comprises adjusting one of an amount of a driving current supplied to the light sources and a duty ratio for driving the light sources.

According to another aspect of the present invention, the plurality of light sources comprises a red light source which outputs red light, a green light source which outputs green light, and a blue light source which outputs blue light, wherein each of the red light source, the green light source, and the blue light source comprises one of a light emitting diode (LED) and a laser.

### BRIEF DESCRIPTION OF THE DRAWINGS

The above and other aspects of the prevent invention will become apparent and more readily appreciated from the following detailed description of exemplary embodiments, taken in conjunction with the accompany drawings, in which:

FIG. 1 is a control block diagram of an image display apparatus according to an exemplary embodiment of the present invention;

FIG. 2 is a control flowchart of an image display apparatus according to a first exemplary embodiment of the present invention; and

FIG. 3 is a control flowchart of an image display apparatus according to a second exemplary embodiment of the present invention.

### DETAILED DESCRIPTION OF THE ILLUSTRATIVE, NON-LIMITING EMBODIMENTS OF THE INVENTION

Reference will now be made in detail to the exemplary embodiments of the present invention, examples of which are illustrated in the accompanying drawings, wherein like reference numerals refer to like elements throughout. The embodiments are described below so as to explain the present invention by referring to the figures.

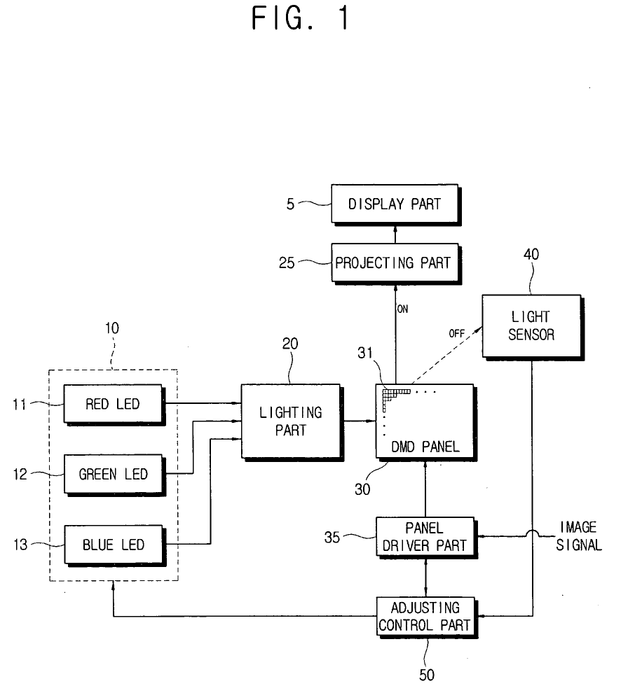

As shown in FIG. 1, an image display apparatus according to a first embodiment of the present invention comprises a display part 5, a plurality of light sources 10, a lighting part 20, a projecting part 25, a DMD panel 30, a panel driving part 35, a light sensor 40, and an adjusting control part 50.

The light sources 10 output light having different colors. The light source 10 includes a red light emitting diode (LED) 11, as a red light source, a green LED 12, as a green light source, and a blue LED 13, as a blue light source, by way of example. Alternatively, the light source 10 may include other lighting sources such as a laser. Also, the light source 10 may include other lighting sources which output light having other colors.

The respective LEDs 11, 12 and 13 sequentially output red, green, and blue light based on a predetermined duty ratio. For example, the duty ratio for driving the respective LEDs 11, 12 and 13 may be 3:3:4, wherein the respective LEDs 11, 12 and 13 would sequentially output red, green, and blue light during times based on the duty ratio 3:3:4 to display one image frame.

The lighting part 20 adjusts the luminous flux of the light source 10 so that the colored light sequentially output from the light source 10 is efficiently directed to respective mirror elements 31 of the DMD panel 30. The lighting part 20 may comprise a relay lens.

The DMD panel 30 comprises a plurality of mirror elements 31 which reflect the light output from the light source 10 in one of a first direction for displaying an image and a second direction different from the first direction. The first and the second directions are reflection directions determined according to inclination angles of the mirror elements 31. Light reflected in the first direction by the mirror elements 31 of the DMD panel 30 is directed to the display part 5 through the projecting part 25 to be used as an image light for displaying an image. Light reflected in the second direction by the mirror elements 31 of the DMD panel 30 is not used for displaying an image. Light reflected in the first direction refers to “on-light”, and light reflected in the second direction refers to “off-light”.

The panel driving part 35 controls the DMD panel 30 so that an image is displayed on the display part 5 according to an input image signal. The panel driving part 35 controls inclination angles of the mirror elements 31 so that each of the mirror elements 31 has one of the first direction and the second direction based on a duty ratio for driving the light sources 10 and red, green and blue gradations of an input image signal.

The projecting part 25 projects on-light from the DMD panel 30 to the display part 5 to be an image light for displaying an image. The projecting part 25 may comprise a projecting lens.

The display part 5 displays an image by means of image light projected through the projecting part 25. The display part 5 may comprise a display panel which displays an image. The display part 5 may be integrally provided with the image display apparatus, but is not limited thereto. Alternatively, the display part 5 may be provided separately from the image display apparatus, and the projecting part 25 may project image light onto an external display part to display an image.

The light sensor 40 is disposed to detect off-light reflected in the second direction by at least one mirror element 31 of the DMD panel 30. The light sensor 40 detects off-light, and outputs a voltage level corresponding to the quantity of the detected off-light, to the adjusting control part 50. Since the respective LEDs 11, 12 and 13 output sequentially colored lights, the light sensor 40 also detects sequential off light corresponding to the colored light output from the respective LEDs 11, 12 and 13.

An image display apparatus according to the first embodiment of the present invention comprises the light sensor 40 for detecting light. Alternatively, an image display apparatus may comprise other detecting parts as long as they can detect the quantity of off-light reflected from the DMD panel.

The adjusting control part 50 determines the quantity of light of the LEDs 11, 12 and 13 based on the detected result by the light sensor 40, and controls light output of the LEDs 11, 12 and 13 based on the determined result.

That is, the adjusting control part 50 determines the intensity of light output from the LEDs 11, 12 and 13 based on the voltage level detected by the light sensor 40. The adjusting control part 50 determines whether the intensity of light of the LEDs 11, 12 and 13 corresponds to a predetermined reference intensity or not, and determines a weight value for the LEDs 11, 12 and 13 so that the intensity of light thereof corresponds to the reference intensity. Then, the adjusting control part 50 controls light output of the LEDs 11, 12 and 13 based on the determined weight value. Here, the reference intensity is predetermined so that the display part 5 displays a normal image by means of light output from the LEDs 11, 12 and 13.

The adjusting control part 50 determines an efficiency of light output from the LEDs 11, 12 and 13 based on a result the light sensor 40 detection of the quantity of off-light reflected in the second direction by the DMD panel 30. If the intensity of light of the LEDs 11, 12 and 13 is smaller than the reference intensity for the corresponding LEDs, the adjusting control part 50 determines a weight value which can increase a light output of the corresponding LEDs to correspond to the reference intensity. Then, the adjusting control part 50 increases light output of the corresponding LEDs according to the determined weight value. Also, in the case that the intensity of light of the LEDs 11, 12 and 13 is larger than the reference intensity for the corresponding LEDs, the adjusting control part 50 determines a weight value which can decrease light output of the corresponding LEDs to correspond to the reference intensity. Then, the adjusting control part 50 decreases light output of the corresponding LEDs according to the determined weight value.

The adjusting control part 50 may control light output of the LEDs 11, 12 and 13 by adjusting the amount of current which is supplied to the LEDs 11, 12 and 13 based on the determined weight value.

For example, if the adjusting control part 50 determines that the intensity of light of the red LED 11 reflected by the DMD panel 30 is 80% with respect to the reference intensity for the red LED 11, the adjusting control part 50 determines a weight value +20% for the red LED 11, and then increases the amount of current for driving the red LED 11 based on the determined weight +20%.

Alternatively, the adjusting control part 50 may determine a relative intensity of light output from the LEDs 11, 12 and 13 based on a voltage level detected by the light sensor 40. Then, the adjusting control part 50 determines a weight value for the LEDs 11, 12 and 13 so that the relative intensity of light of the LEDs 11, 12 and 13 corresponds to a predetermined relative reference intensity. Then, the adjusting control part 50 controls light output of the LEDs 11, 12 and 13 based on the determined weight value. Here, the relative reference intensity is predetermined so that the display part 5 displays a normal image by means of light output from the respective LEDs 11, 12 and 13.

Here, the adjusting control part 50 may control light output of the LEDs 11, 12 and 13 by adjusting a duty ratio for driving the LEDs 11, 12 and 13 based on the determined weight value so that the relative intensity of the LEDs 11, 12 and 13 corresponds to the relative reference intensity.

For example, if the adjusting control part 50 determines that the intensity of light of the red LED 11 reflected by the DMD panel 30 is 80% with respect to the relative reference intensity for the red LED 11, and the intensity of light of the green LED 12 and the blue LED 13 reflected by the DMD panel 30 is 110% with respect to the relative reference intensity for the green LED 12 and the blue LED 13, the adjusting control part 50 determines respective weight values so that light output of the red LED 11 increases and light output of the green LED 12 and the blue LED 13 decreases. Then the adjusting control part 50 may adjust a duty ratio for driving the respective LEDs 11, 12 and 13 based on the determined weight value from 3:3:4 to 4:2.5:3.5.

The adjusting control part 50 may repeatedly adjust the light output of the respective LEDs 11, 12 and 13 based on a predetermined period of time. That is, the adjusting control part 50 may periodically perform the foregoing operations, instead of performing them based on receipt of the detecting results from the light sensor 40.

Accordingly, an image display apparatus according to the first embodiment of the present invention may determine the quantity of light of the LEDs 11, 12 and 13, and may thereby determine the efficiency of light output thereby by using off-light which is not used for displaying an image. Then, the image display apparatus may determine a weight value for the LEDs 11, 12 and 13 based on the determined efficiency of light output therefrom, and may thereby adjust light output thereof.

Thus, an image display apparatus according to the present invention may allow the LEDs 11, 12 and 13 to output light having an intensity with which the display part 5 can display a normal image. Accordingly, the efficiency of the light sources outputting colored light may be different, the image display apparatus can adjust light output of the light sources, and can thereby prevent image distortion.

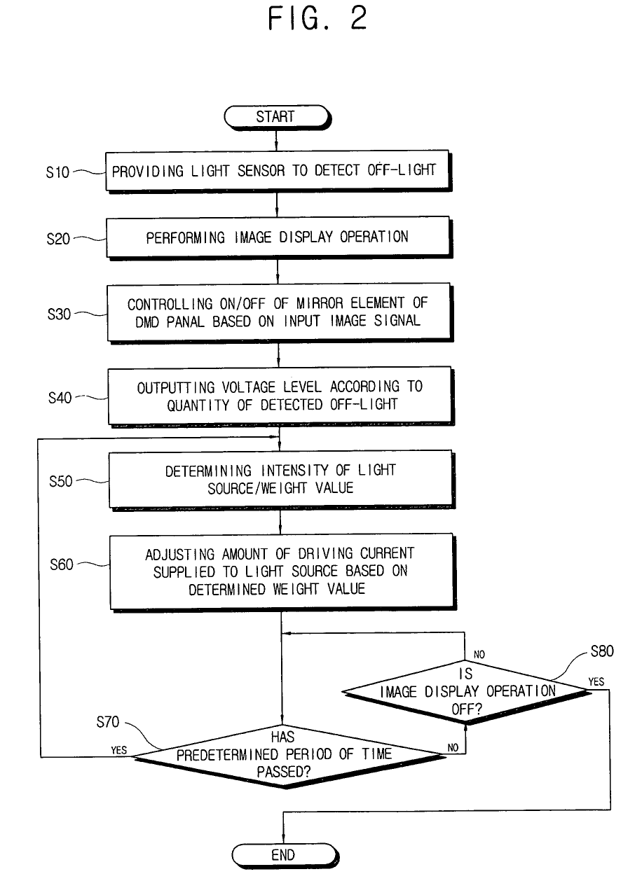

Hereinafter, a control method for an image display apparatus according to the first exemplary embodiment of the present invention will be described with reference to FIGS. 1 and 2.

As shown in FIGS. 1 and 2, the light sensor 40 is provided to detect off-light reflected in the second direction by mirror elements 31 of the DMD panel 30 (S10). The light sensor 40 detects the quantity of reflected light. Then, an image signal is input to the image display apparatus, and an image display operation is performed (S20). Then, the panel driving part 35 controls inclination angles of the mirror elements 31 of the DMD panel 30 so that a display part 5 displays an image according to the input image signal (S30). The light sensor 40 detects off-light and outputs a voltage level corresponding to the quantity of the detected off light, to an adjusting control part 50 (S40).

The adjusting control part 50 determines the intensity of light output from LEDs 11, 12 and 13 based on a voltage level detected by the light sensor 40. Then, the adjusting control part 50 determines whether the intensity of light of the LEDs 11, 12 and 13 corresponds to a predetermined reference intensity for the LEDs 11, 12 and 13, and determines a weight value for the LEDs 11, 12 and 13 so that the intensity of light thereof corresponds to the reference intensity (S50). Then, the adjusting control part 50 controls the light output of the LEDs 11, 12 and 13 based on the determined weight value. That is, the adjusting control part 50 increases or decreases the amount of current for driving the LEDs 11, 12 and 13 according to the determined weight value (S60).

Then, the adjusting control part 50 determines whether a predetermined period of time has passed (S70). If the period of time has passed, the adjusting control part 50 performs the operations S50 and S60 again. If the period of time has not passed, the adjusting control part 50 ignores the result which the light sensor 40 detects, and determines whether the image display operation is off (S80). Here, the off of the image display operation means that the panel driving part 35 stops driving the DMD panel 31 for displaying an image. If the adjusting control part 50 determines that the image display operation is off, the adjusting control part 50 finishes adjusting the light output of the respective LEDs 11, 12 and 13.

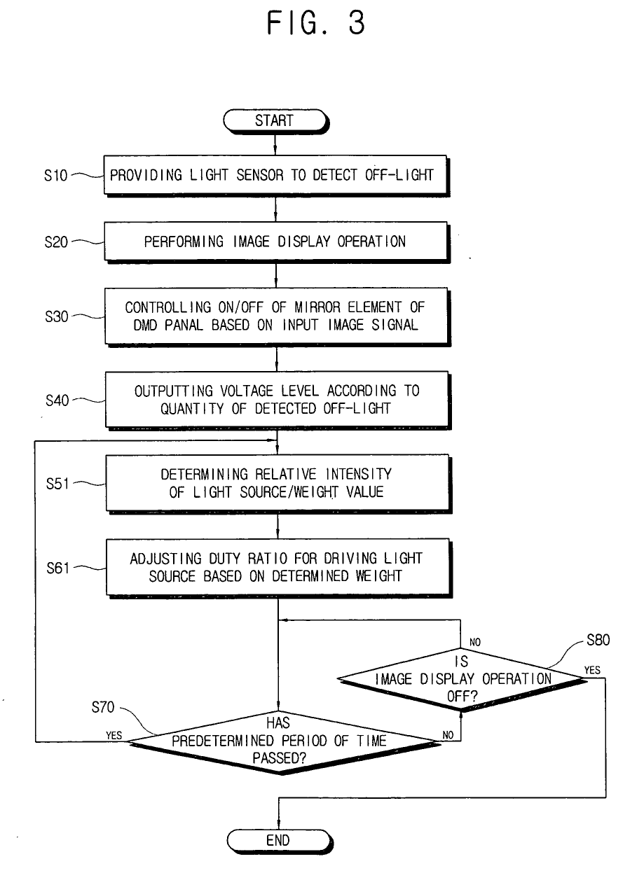

Hereinafter, a control method for an image display apparatus according to a second embodiment of the present invention will be described by referring to FIGS. 1 and 3.

As shown in FIGS. 1 and 3, a control method for an image display apparatus according to the second embodiment of the present invention includes the same stages as the stages S10 to S40 of the control method for the image display apparatus according to the first embodiment of the present invention.

An adjusting control part 50 determines a relative intensity of light output from LEDs 11, 12 and 13 based on a voltage level detected by a light sensor 40. Then, the adjusting control part 50 determines whether the determined relative intensity of light of the LEDs 11, 12 and 13 corresponds to a predetermined relative reference intensity corresponding to the LEDs 11, 12 and 13, and determines a weight value for the LEDs 11, 12 and 13 so that the relative intensity of light thereof corresponds to the relative reference intensity (S51). Then, the adjusting control part 50 controls the light output of the respective LEDs 11, 12 and 13 based on the determined weight value. That is, the adjusting control part 50 increases or decreases a duty ratio for driving the LEDs 11, 12 and 13 according to the determined weight value (S61).

Then, the adjusting control part 50 determines whether a predetermined period of time has passed (S70). If the period of time has passed, the adjusting control part 50 performs the operations S50 and S60 again. If the period of time has not passed, the adjusting control part 50 ignores the result which the light sensor 40 detects, and determines whether the image display operation is off (S80). If the image display operation is off, this means that the panel driving part 35 stops driving the DMD panel 31 for displaying an image. If the adjusting control part 50 determines that the image display operation is off, the adjusting control part 50 finishes adjusting the light output of the LEDs 11, 12 and 13.

As described above, an image display apparatus and a control method therefor according to exemplary embodiments of the present invention can adjust the light output of the LEDs 11, 12 and 13 by using off-light, and can allow the LEDs 11, 12 and 13 to output light having an intensity with which the display part 5 can display a normal image. Accordingly, although the efficiency of the light sources outputting colored light may be different, the image display apparatus and the control method therefor can adjust the light output of the light sources to thereby prevent image distortion.

As described above, an image display apparatus and a control method therefor according to the exemplary embodiments of the present invention can adjust the light output of light sources by using off light which is not used for displaying an image, and can thereby prevent image distortion although the efficiency of the light sources may be different.

Although exemplary embodiments of the present invention have been shown and described, it will be appreciated by those skilled in the art that changes may be made in these embodiments without departing from the principles and spirit of the invention, the scope of which is defined by the appended claims and their equivalents.

What is claimed is:

1. An image display apparatus comprising:
a plurality of light sources, each of the light sources outputting a different color light;
a digital micro mirror device (DMD) panel comprising a plurality of mirror elements which reflect the light output from the light sources in one of a first direction for displaying an image and a second direction different from the first direction;
a detecting part which detects a quantity of light reflected in the second direction by at least one mirror element of the DMD panel; and
an adjusting control part which determines a quantity of light output by the light sources based on the detection by the detecting part, and adjusts a light output of the light sources based on the determined quantity of light.

2. The image display apparatus according to claim 1, wherein the detecting part comprises a light sensor which detects light and outputs, to the adjusting control part, a voltage level corresponding to a quantity of the detected light.

3. The image display apparatus according to claim 2, wherein the adjusting control part determines an intensity of light output from the light sources based on the voltage level output by the detecting part, determines a weight value for the light sources so that the determined intensity of light of the light sources corresponds to a reference intensity for the light sources, and adjusts the light output of the light sources based on the weight value.

4. The image display apparatus according to claim 1, wherein the adjusting control part determines the intensity of light output from the light sources based on the quantity of light detected by the detecting part, determines a weight value for the light sources so that the determined intensity of light of the respective light sources corresponds to a reference intensity for the respective light sources, and adjusts the light output of the light sources based on the weight value.

5. The image display apparatus according to claim 1, wherein the adjusting control part determines a relative intensity of light output from the respective light sources based on the quantity of light detected by the detecting part, determines a weight value for the light sources so that the determined relative intensity of light of the light sources corresponds to a relative reference intensity, and adjusts the light output of the light sources based on the weight value.

6. The image display apparatus according to claim 4, wherein, to control the light output of the light sources according to the weight value, the adjusting control part adjusts one of the amount of a driving current supplied to the light sources and a duty ratio for driving the light sources.

7. The image display apparatus according to claim 6, wherein the adjusting control part adjusts the light output of the light sources based on a period of time.

8. The image display apparatus according to claim 7, wherein the light sources comprise a red light source which outputs red light, a green light source which outputs green light, and a blue light source which outputs blue light, and each of the red light source, the green light source, and the blue light source comprises one of a light emitting diode and a laser.

9. The image display apparatus according to claim 8, further comprising:
a display part which displays an image; and
a panel driving part which controls the DMD panel so that each of the mirror elements is disposed to reflect in one of the first direction and the second direction based on an input image signal, and controls the display part to display an image according to the image signal.

10. The image display apparatus according to claim 5, wherein, to control the light output of the respective light sources according to the weight value, the adjusting control part adjusts one of the amount of a driving current supplied to the light sources and a duty ratio for driving the light sources.

11. The image display apparatus according to claim 10, wherein the adjusting control part adjusts the light output of the light sources based on a period of time.

12. The image display apparatus according to claim 11, wherein the light sources comprise a red light source which outputs red light, a green light source which outputs green light, and a blue light source which outputs blue light, and each of the red light source, the green light source, and the blue light source comprises one of a light emitting diode and a laser.

13. The image display apparatus according to claim 12, further comprising:
a display part which displays an image; and
a panel driving part which controls the DMD panel so that each of the mirror elements is disposed to reflect in one of the first direction and the second direction based on an input image signal, and controls the display part to display an image according to the image signal.

14. A control method for an image display apparatus comprising a digital micro mirror device (DMD) panel with reflects light in one of a first direction for displaying an image and a second direction different from the first direction, the control method comprising:
providing a plurality of light sources, wherein each of the light sources output light having a different color;
detecting a quantity of light reflected by the DMD panel in the second direction;
determining a quantity of light output by the light sources based on the quantity of light which is detected; and
adjusting a light output of the light sources based on the determined quantity of light output by the light sources.

15. The control method according to claim 14, wherein the detecting the quantity of light reflected by the DMD panel in the second direction is performed by a detecting part comprising a light sensor which detects light and outputs a voltage level corresponding to the detected quantity of light reflected by the DMD panel in the second direction.

16. The control method according to claim 15, wherein the determining the quantity of light output by the light sources comprises:
determining an intensity of light output from the light sources based on the voltage level output by the detecting part, and
determining a weight value for the light sources such that the determined intensity of light of the light output from the light sources corresponds to a predetermined reference intensity for the light output by the light sources.

17. The control method according to claim 15, wherein the determining the quantity of light output by the light sources comprises:
determining a relative intensity of light output from the light sources based on the voltage level output by the detecting part, and
determining a weight value for the light sources such that the determined relative intensity of light output by the light sources corresponds to a predetermined relative reference intensity for the light output by the light sources.

18. The control method according to claim 16, wherein the adjusting the quantity of light output by the light sources comprises adjusting the quantity of light output by the light sources based on the determined weight value.

19. The control method according to claim 18, wherein the adjusting the quantity of light output by the light sources further comprises adjusting one of an amount of a driving current supplied to the light sources and a duty ratio for driving the light sources.

20. The control method according to claim 19, wherein the plurality of light sources comprises a red light source which outputs red light, a green light source which outputs green light, and a blue light source which outputs blue light, and
each of the red light source, the green light source, and the blue light source comprises one of a light emitting diode and a laser.

21. The control method according to claim 17, wherein the adjusting the quantity of light output by the light sources comprises adjusting the quantity of light output by the light sources based on the determined weight value.

22. The control method according to claim 21, wherein the adjusting the quantity of light output by the light sources further comprises adjusting one of an amount of a driving current supplied to the light sources and a duty ratio for driving the light sources.

23. The control method according to claim 22, wherein the plurality of light sources comprises a red light source which outputs red light, a green light source which outputs green light, and a blue light source which outputs blue light, and
each of the red light source, the green light source, and the blue light source comprises one of a light emitting diode and a laser.
